(19) United States
(12) Patent Application Publication
(10) Pub. No.: US 2012/0131245 A1
(43) Pub. Date: May 24, 2012

(54) TRANSFER OF CONTROL BUS SIGNALING ON PACKET-SWITCHED NETWORK

(75) Inventor: Richard J. Wilcox, Sagle, ID (US)

(73) Assignee: SILICON IMAGE, INC., Sunnyvale, CA (US)

(21) Appl. No.: 12/950,867

(22) Filed: Nov. 19, 2010

(51) Int. Cl. G06F 13/42

(52) U.S. Cl. 710/106

(57) ABSTRACT

Embodiments of the invention are generally directed to transfer of control bus signaling on a packet-switched network. An embodiment of a method includes sending control signals from a first device on a first control bus, the control signals being sent according to an interface protocol, the control signals being intended for a second device. The method further includes detecting a current state of the first control bus, where the current state is a control signal value driven by the first device; inserting a control signal representing the current state of the control bus into a data packet; and transmitting the data packet to the second device via a packet-switched network.

### TECHNICAL FIELD

Embodiments of the invention generally relate to the field of electronic devices and, more particularly, to transfer of control bus signaling on a packet-switched network.

### BACKGROUND

Homes and other personal spaces may include numerous electronic devices, including entertainment devices, such as televisions, video players, audio sound systems, gaming systems, personal computers, and mobile devices. Such devices are increasingly connected or networked together to allow for the transfer of data, such as multimedia data for display, between such devices.

Networks of devices may include HDMI™ (High Definition Multimedia Interface 1.4 Specification, issued May 28, 2009) data protocol and MHL™ (Mobile High-Definition Link) data protocol. MHL is an interface protocol that provides for connection of a mobile device to an HDMI display device. Such protocols allow for the transfer of high definition multimedia data between certain devices. HDMI includes the use of a CEC (Consumer Electronics Control) bus for the transfer of control signal data between devices, where the CEC bus is a single-wire, bi-directional bus.

However, an interface for the transfer of multimedia may commonly be defined in terms of a direct electrical connection between a first device and a second device and the transfer of data between such devices. A device that operates under such a protocol is generally limited in operation to such connections between devices.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of an embodiment of conversion of control bus signaling to a packet-switched network;

FIG. 2 is an illustration of an HDMI interface;

FIG. 3 is an illustration of an embodiment of the transfer of control bus signals via a packet-switched network;

FIG. 4 is an illustration of an embodiment of a process for inserting control signal values into data packets for transfer;

FIG. 5 is an illustration of embodiments of apparatuses for transmission and reception of control signals on a packet-switched network;

FIG. 6 is a chart to illustrate operation of elements of apparatuses for transmission and reception of control signals on a packet-switched network;

FIG. 7 is a flowchart to illustrate a process for transmitting control signals via a packet-switched network;

FIG. 8 is a flowchart to illustrate a process for receiving control signals via a packet-switched network;

FIG. 9 is an illustration of an embodiment of transfer of control signals between consumer electronic devices; and

FIG. 10 illustrates an embodiment of an electronic device for transmitting or receiving signal data.

### SUMMARY

Embodiments of the invention are generally directed to transfer of control bus signaling on a packet-switched network.

In a first aspect of the invention, an embodiment of a method includes sending control signals from a first device on a first control bus, the control signals being sent according to an interface protocol, the control signals being intended for a second device. The method further includes detecting a current state of the first control bus, where the current state is a control signal value driven by the first device; inserting a control signal representing the current state of the control bus into a data packet, and transmitting the data packet to the second device via a packet-switched network.

In a second aspect of the invention, an apparatus includes an interface with a first control bus and an interface with a packet-switched network. The apparatus further includes a control circuit, where the control circuit includes an element to detect a current state of the first control bus, and an element to insert a value representing the current state of the first control bus into a data packet for transmission over the packet-switched network.

### DETAILED DESCRIPTION

Embodiments of the invention are generally directed to transfer of control bus signaling on a packet-switched network.

In some embodiments, a method or apparatus provided for operations of a control bus between electronic devices using a packet-switched network. In some embodiments, bits representing the control bus signals are transferred in data packets in a manner such that the control signal transport appears to be the operation of a standard control bus operation to both the transmitting device and the receiving device.

In some embodiments, the control bus is a single-wire, CEC (Consumer Electronics Control) bus for HDMI operation. The CEC bus is defined in the HDMI specification as a wire-ORed common single-wire bus for the purpose of conveying control information between consumer electronic devices. The electrical and protocol specifications are designed to operate with devices electrically direct-attached to the common CEC bus.

However, with the advent of network-based packet switched transport of audio, video, and control information between consumer electronic devices, a direct electrical attachment of the CEC bus may be impractical.

In some embodiments, a method or apparatus provides for the transport of control messages over a packet-switched network while maintaining original behavior and characteristics for the control bus as detected by the transmitting device and the receiving device. In some embodiments, a method or apparatus for transporting CEC control information via a packet-switched network is provided, while maintaining the behavior and electrical characteristics of the defined CEC bus. In some embodiments, a method or apparatus provides a practical solution for converting CEC electrical transitions into data that may be transmitted and received in network packets. Conversely, control data received in network packets may be reconstructed into CEC-compatible electrical signaling.

In some embodiments, the current state of a local CEC bus is monitored and conveyed as a single-bit field in packets flowing between two devices. In some embodiments, when one or more data packets are currently queued for transmission, a current CEC state (high or low signal, ‘1’ or ‘0’ logical state) may be reflected as a single bit in a packet header of a data packet, thus allowing “piggybacking” the transport of the control bus data onto existing network traffic.

In some embodiments, in cases where a transition occurs on the CEC bus when there are no packets queued for transmission, a separate control packet may be transmitted, with a single header bit reflecting the state of the CEC bus. In this manner, data is transmitted in existing packet traffic when existing data packets are available, and is transmitted in inserted data packets when there are no available data packets.

In some embodiments, the data bits representing the state of the control bus are detected in received data packets, and such data bits are applied to a second CEC bus for transport to the receiving device. Thus, a transmitting device may apply control signals to a first CEC bus in the normal fashion for HDMI signals, and a receiving device may detect the control signals from a second CEC bus in the normal fashion for HDMI signals, without either the transmitting device or the receiving device being required to deviate from standard control signal operation.

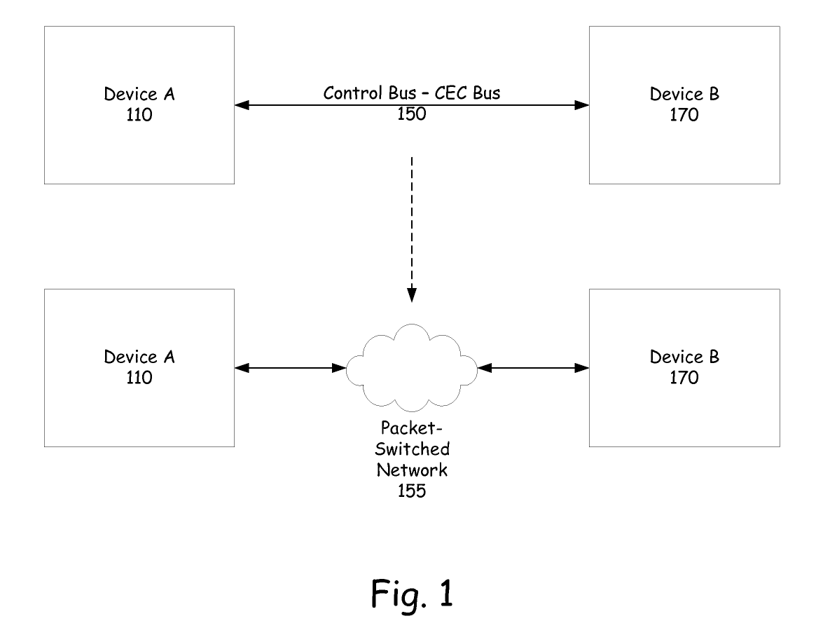

FIG. 1 is an illustration of an embodiment of conversion of control bus signaling to a packet-switched network. In this illustration, Device A 110 and Device B 170 are connected, including a connection for transfer of control signals between Device A and Device B. In some embodiments, while under the normal protocol (such as HDMI protocol) the devices would transfer data over a control bus (such as control bus 150, which may be a CEC bus), the control signals are instead transferred via a packet-switched network 155. However, the signals are transferred in such a manner that the transfer appears to Device A 110 and Device B 170 to be a standard transfer over control bus 150.

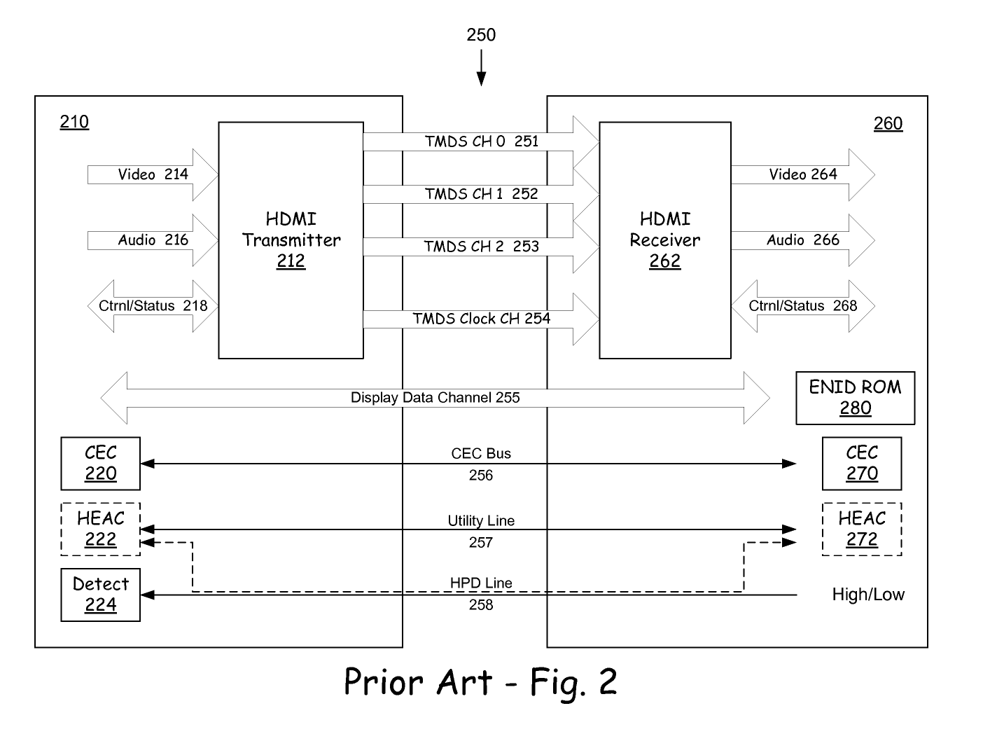

FIG. 2 is an illustration of an HDMI interface. As illustrated in FIG. 2, an HDMI interface 250 between a source device 210 and a sink device 260 includes a CEC bus 256 (shown linking a CEC element 220 of the source 210 with a CEC element 270 of the sink 260). The CEC is a single-wire, bi-directional serial bus, as defined by the CEC specification of HDMI, for the performance of control functions.

The HDMI interface further includes three TMDS (Transition Minimized Differential Signaling) data channels 251-253 for the transfer of video data (214, 264), audio data (216, 266), and certain control and status information 218, 268, and includes a TMDS clock channel 254. Also included is a Display Data Channel 255 to allow the Source 210 to read the Sink's Extended Display Identification Data (EDID) 280, a utility line 257 for the HDMI Ethernet and Audio Return Channel (HEAC) (222, 272), and a hot plug detect (HPD) line 258 for use in detection 224 of a connection.

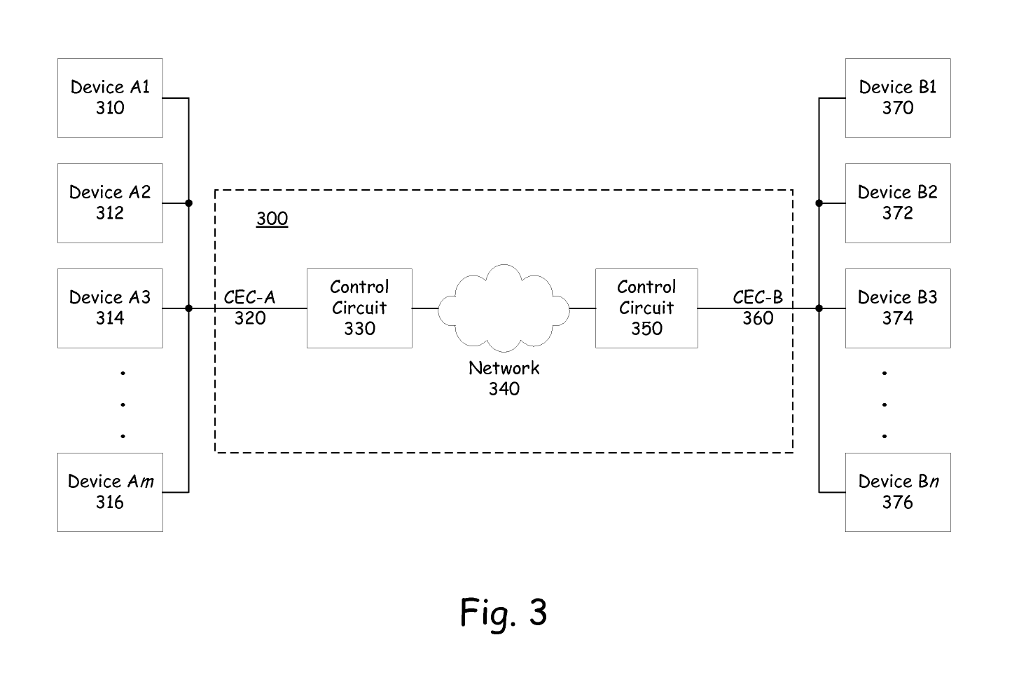

FIG. 3 is an illustration of an embodiment of the transfer of control bus signals via a packet-switched network. FIG. 3 illustrates a topology of an embodiment of a mechanism for transporting control signals via a packet-switched network. In some embodiments, a connection 300 may include two CEC common wire-OR buses (a first control bus CEC-A 320 and a second control bus CEC-B 360) interconnected with a packet-switched network.

In some embodiments, the separate CEC buses 320 and 360 appear as a single wire-OR CEC bus to all connected devices. Each CEC transmission control circuit is responsible for conveying the local CEC bus state to the remote CEC control circuit. In some embodiments, upon receipt of the remote CEC bus state, the receiving control circuit is responsible for driving the remote CEC state on its local CEC bus.

In some embodiments, each device assumes that it has a direct connection to all other devices and that detection of another device driving the bus is “instantaneous”. A challenge in conveying this behavior over a packet-switched network is the need to receive a remote CEC bus state to drive a local CEC state, and conversely to convey a local CEC state to a remote CEC bus. In some embodiments, the single-wire behavior is emulated for both the transmitting device and the receiving device in a data transfer.

In this illustration, one or more devices (shown as Device A1 310, Device A2 312, Device A3 314, and continuing through an mth device Device Am 316) are connected to control bus CEC-A 320, while one or more devices (shown as Device B1 370, Device B2 372, Device B3 374, and continuing through an nth device (Device Bn 376) are connected to control bus CEC-B 360. In some embodiments, the control buses are connected to control circuits that provide for transferring the signals across a packet-switched network. In this illustration, the first control bus CEC-A 320 is connected to control circuit 330, which provides a link to network 340. Further, the second control bus CEC-B 360 is connected to control circuit 350, which also provides a link to network 340. While in this illustration, the control circuits are shown as separate units, embodiments are not limited to any particular physical location of the control circuits, and such control circuits may be included within the illustrated devices, within switching devices, or within other elements in a network.

In some embodiments, control circuit 330 detects control signal values on CEC-A 320 from one of the devices A1-Am 310-316, and inserts such values into data packets for transmission via network 340. In some embodiments, each signal value is a single bit (with a high or low, ‘1’ or ‘0’ value) that may be inserted in a header of a data packet. In some embodiments, the control signal values are inserted into waiting data packets if such packets are available, with data packets being generated to transmit control signal values if no waiting data packets are available. In some embodiments, control circuit 350 detects control signal values in data packets received via the network 340. Further, the control circuit 350 operates to apply the values of the received control signals on CEC-B 360 for detection by one of the devices B1-Bn 370-376.

In some embodiments, control signals are also transferred in the reverse direction, where control circuit 350 detects control signal values on CEC-B 360 from one of the devices B1-Bn 370-376, and inserts such values into data packets for transmission via network 340; and where control circuit 330 detects control signal values in data packets received via the network 340 and operates to apply the values of the received control signals on CEC-A 320 for detection by one of the devices A1-Am 310-316.

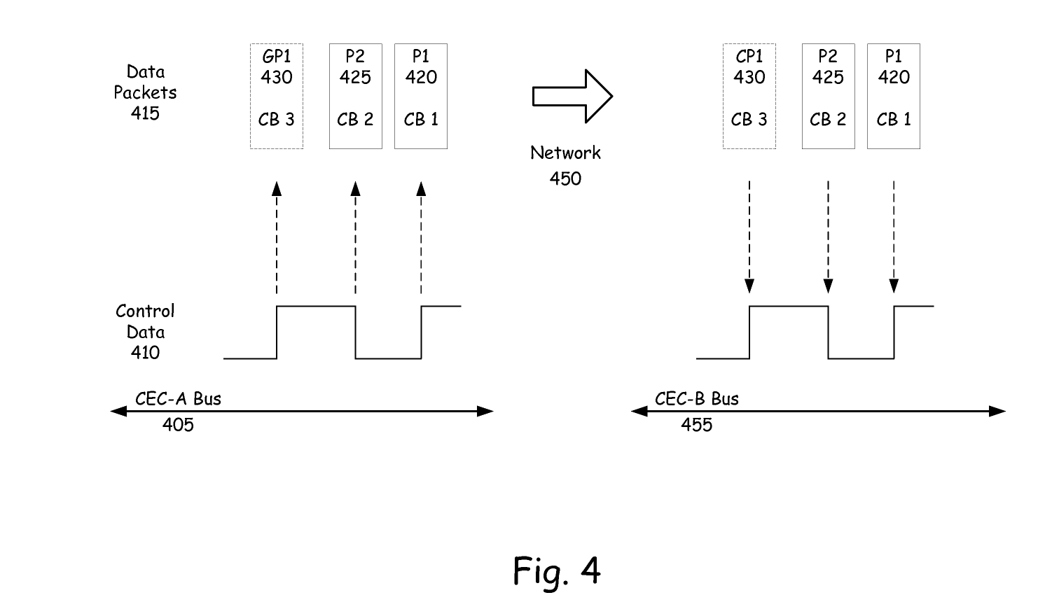

FIG. 4 is an illustration of an embodiment of a process for inserting control signal values into data packets for transfer. In some embodiments, a first single-wire control bus such as CEC-A 405 is used to provide control signal data 410. In some embodiments, the control signal data 410 is detected and inserted into the headers of data packets 415 being transferred on a packet-switched network.

In this illustration, a first bit of control data (control bit 1, designated as CB 1) is inserted into a first available data packet P1 420, and a second bit of control data (CB 2) is inserted into a second available data packet P2 425. As provided in FIG. 4, there is no data packet available for the following bit of control data (CB 3), and thus a data packet is generated (where the generated data packet is designated as GP1 430 for the purpose of transferring the control bit, with CB 3 being inserted as the header of GP1 430.

In some embodiments, the data packets 420-430 are transferred via a packet-switched network 450. In some embodiments, the control data bits CB 1, CB 2, and CB 3 are obtained from the data packets and are applied to a second control bus, shown as single-wire bus CEC-B 455, for detection by the intended recipient of the control data.

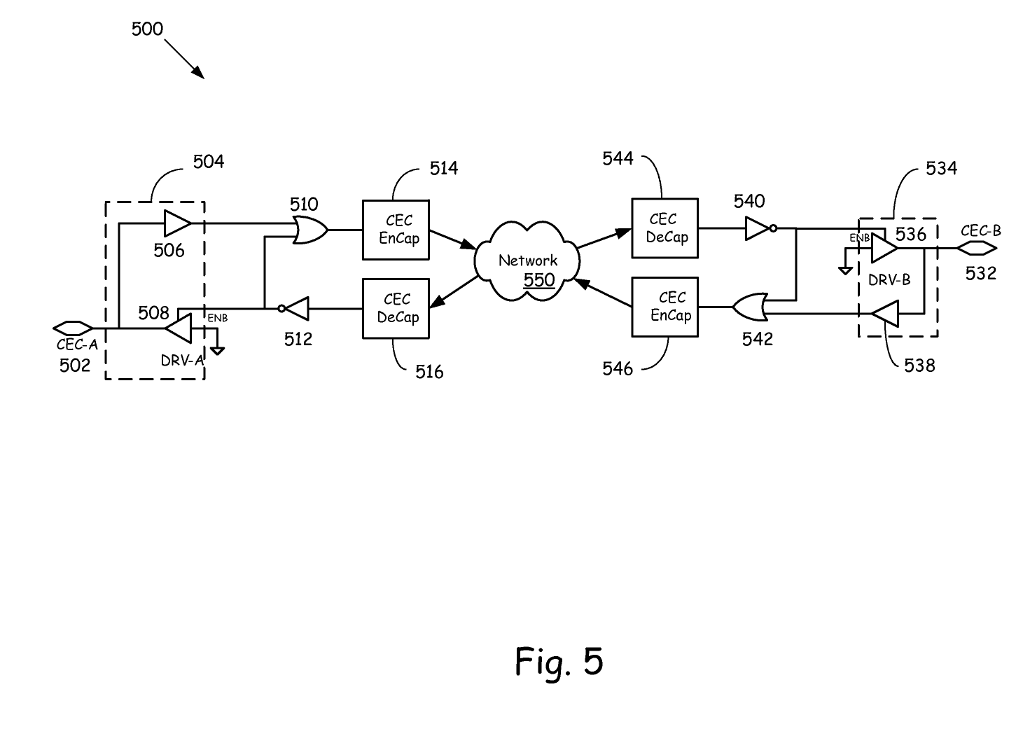

FIG. 5 is an illustration of embodiments of apparatuses for transmission and reception of control signals on a packet-switched network. In some embodiments, a system 500 for transferring control signal data includes a connection to a first control bus CEC-A 502 to provide control bus operation for one or more devices and a connection to a second control bus CEC-B 532 to provide control bus operation for one or more devices. In some embodiments, control bus CEC-A 502 is coupled with a first circuit element 504 including a buffer 506 to detect a signal on CEC-A 502 and provide the signal to an input of OR gate 510, which in turn is coupled with encapsulation component 514 (CEC EnCap) to insert the appropriate signal in a data packet for transmission via network 550.

In some embodiments, a de-encapsulation component (CEC DeCap) 544 then operates to obtain the control signal from the data packet received on the network 550. The control signal is inverted by inverter 540 and applied to enable a driver (DRV-B) 536 to apply the control signal to control bus CEC-B 532.

Similarly, in some embodiments a buffer 538 operates to detect a signal on CEC-B 532 and provide the signal to an input of OR gate 542, which in turn is coupled with encapsulation component 546 (CEC EnCap) to insert the appropriate signal in a data packet for transmission via the network 550.

In some embodiments, a de-encapsulation component (CEC DeCap) 516 then operates to obtain the control signal from the data packet received on the network 550. The control signal is inverted by inverter 512 and applied to enable a driver (DRV-A) 508 to apply the control signal to control bus CEC-A 502.

If control circuits simply drive the received remote CEC state onto the local bus, then upon transition of either the local or remote CEC bus to a zero level, all buses will latch to a zero state. In some embodiments, the control circuit is to drive the local CEC bus from the remote CEC state only when the local CEC bus is not being driven by a local device. In some embodiments, this logic is utilized to prevent a latch-up state, with the operation of such logic operating at the expense of a delay in the assertion of the remote state to the local bus.

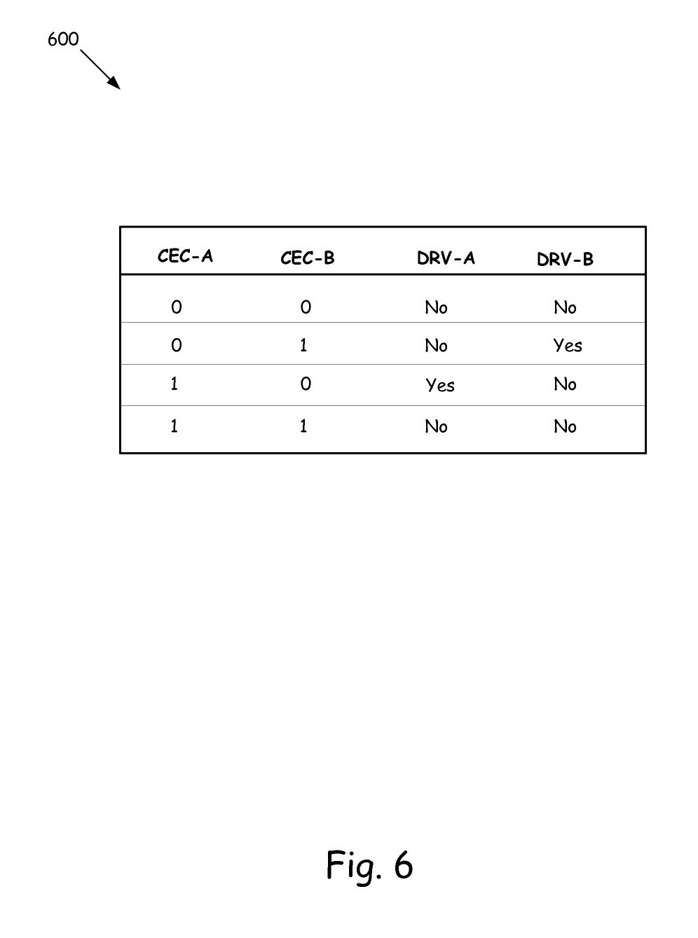

FIG. 6 is a chart to illustrate operation of elements of apparatuses for transmission and reception of control signals on a packet-switched network. The chart 600 provides operational information for the system illustrated in FIG. 5. As illustrated in chart 600, if control bus CEC-A and CEC-B are both at ‘0’, then neither driver DRV-A or DRV-B is enabled. If CEC-A only is ‘1’, then DRV-A is active. If CEC-B only is ‘1’, then DRV-B is active. However, if both CEC-A and CEC-B are ‘1’, then neither driver DRV-A or DRV-B is enabled.

In some embodiments, due to the need to condition the signals as described above, additional delays may be incurred in the transfer of the CEC state between devices. In order to de-assert the remote signal from the local bus, a CEC state packet is transferred in each direction. For example, the HDMI-CEC specification defines a 2.4 ms nominal bit time with a 200 μs window around following each edge. Network transmission times that cause the conveyed CEC signal to be delayed beyond this window will be non-compliant with the specification. Further, any delay added to the existing specification may cause non-compliance with devices that operate at worst-case timing. In some embodiments, in order to maintain interoperability, network latency may be kept at a low level and connected devices may be required to operate near nominal CEC timing.

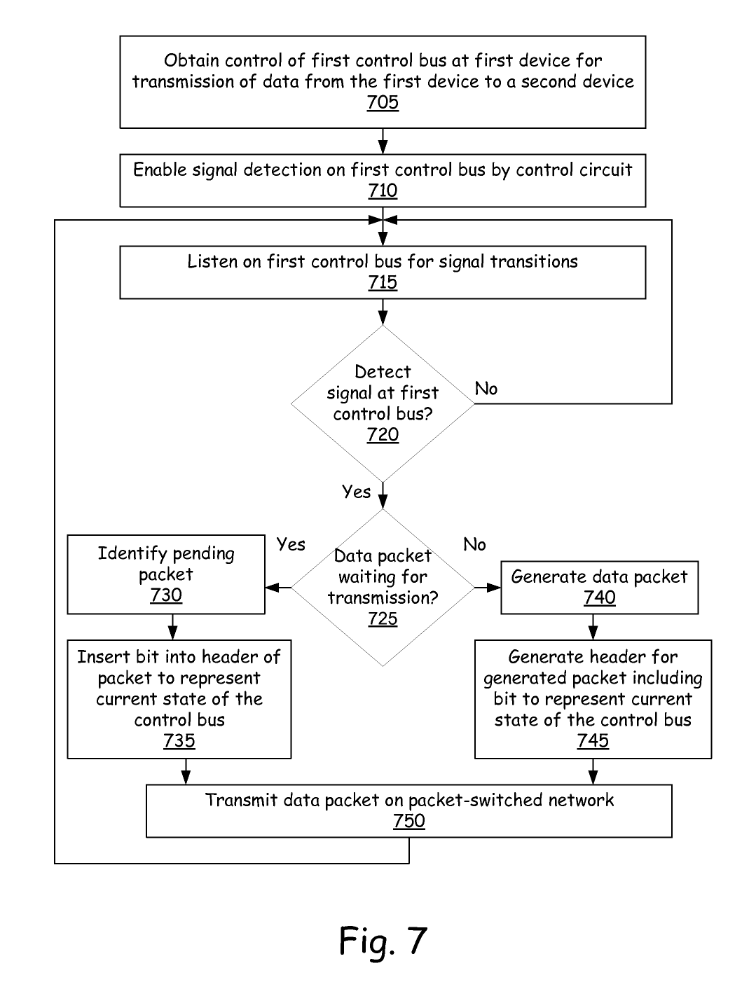

FIG. 7 is a flowchart to illustrate a process for transmitting control signals via a packet-switched network. In some embodiments, a first device obtains control of a first control bus in connection with transmission of data from the first device to the second device 705. In some embodiments, signal detection is enabled on the first control circuit by a control circuit 710, and the control circuit operates to listen to the first control bus for control signals 715. If a control signal is detected on the first control bus 720, then there is a determination whether a data packet that is waiting for transmission is available to transport the control signal 725. If so, a pending data packet is identified 730 and a bit representing the current state of the first control bus is inserted into the header of the identified data packet 735. If no waiting data packet is available to carry the control signal, then a data packet is generated to carry the data 740, and a header is generate that includes the control data signal 745. For both an existing data packet and a generated data packet, the data packet is transmitted on a packet-switched network 750 to carry the control signal to the intended recipient.

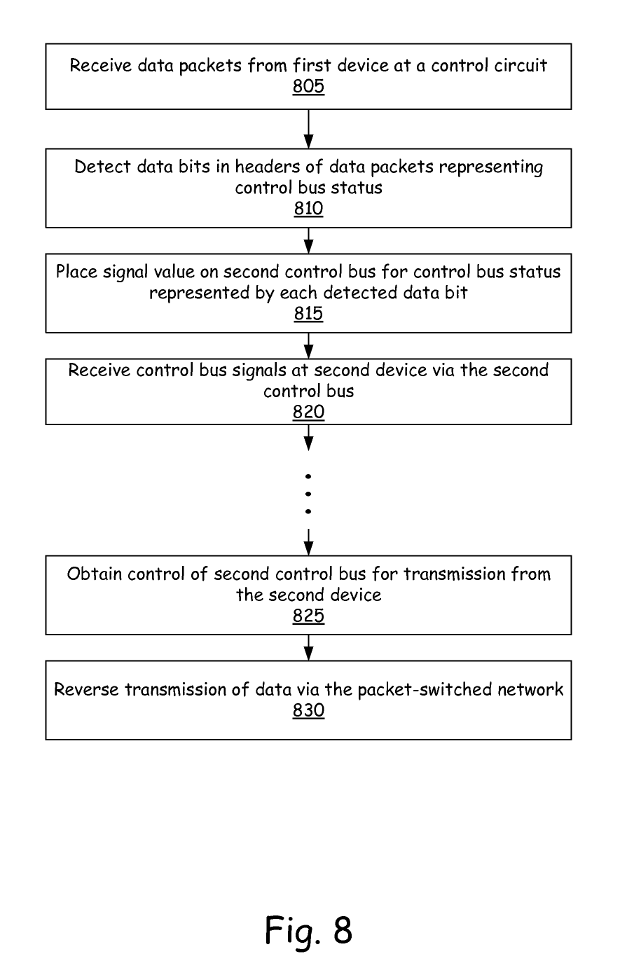

FIG. 8 is a flowchart to illustrate a process for receiving control signals via a packet-switched network. In some embodiments, data packets from a first device are received at a control circuit 805. Data bits in the headers of the data packets representing a state of a first control bus, and thus the value of a control signal, are detected 810. The control signal values represented by the detected data bits are then placed on a second control bus 815, and the control bus signals are received by a second device bit via the second control bus 820.

In some embodiments, the transmission of control data may be made from the second device to the first. If necessary, control of the second control bus is obtained by the second device for transmission of signals 825, and the transmission of data is reversed through the packet-switched network 830.

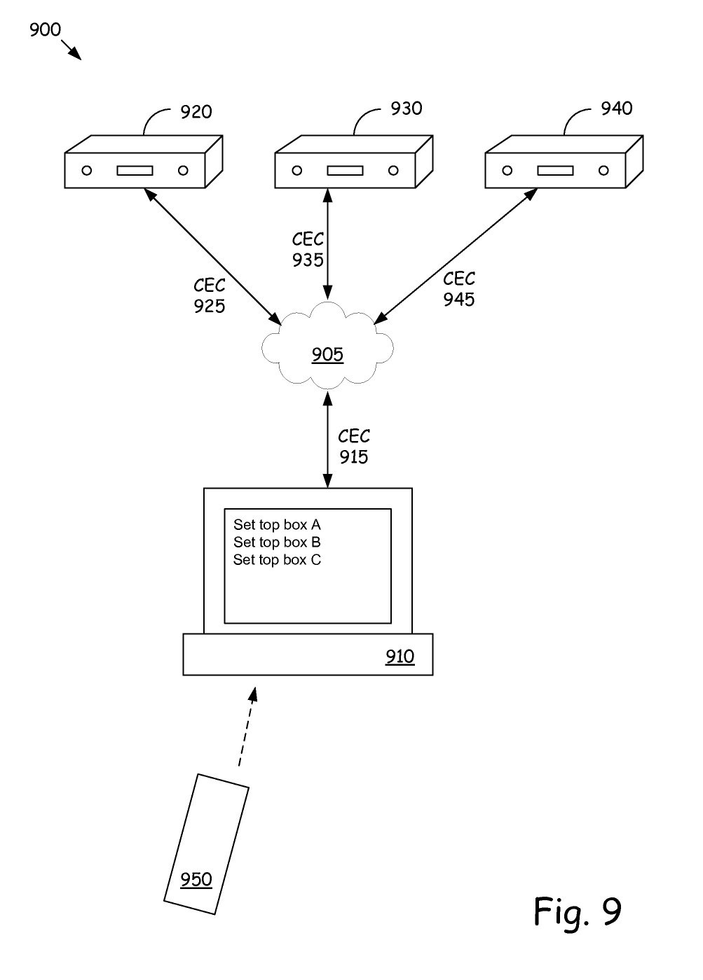

FIG. 9 is an illustration of an embodiment of transfer of control signals between consumer electronic devices. In some embodiments, CEC protocol may used to convey commands, such as those transmitted by a remote control, to various devices in a home entertainment network 900. In some embodiments, a remote control 950 may be used to direct a television 910 to display a list of available set-top boxes, illustrated as set-top boxes 920, 930, and 940. The set-top boxes may be located in various locations in the physical area of the home entertainment network 900. In some embodiments, the television is connected to a packet-switched network 905 by CEC bus 915 and set-top boxes 920, 930, and 940 are connected to the network 905 respectively by CEC buses 925, 935, and 945 via control circuits, such as the control circuits 330 and 350 illustrated in FIG. 3.

In some embodiments, the remote control 950 may be used to select one of the set-top boxes, such as set-top box 920, and to key commands directly to the selected set-top box 920 with the same remote control 950 via the CEC buses 915 and 925 even though the selected set-top box is not necessarily located in the same room as the television 910. In this example, the television 910 utilizes the CEC bus 915 and CEC protocol to forward the appropriate commands to the selected box 920, which will receive the commands via the CEC bus 925. In some embodiments, the devices will transfer the commands from the CEC buses to data packets for transmission via the packet-switched network 905. In some embodiments, the television 910 and selected set-top box 920 will each operate as if the devices were directly connected by a single CEC bus for the transmission of commands.

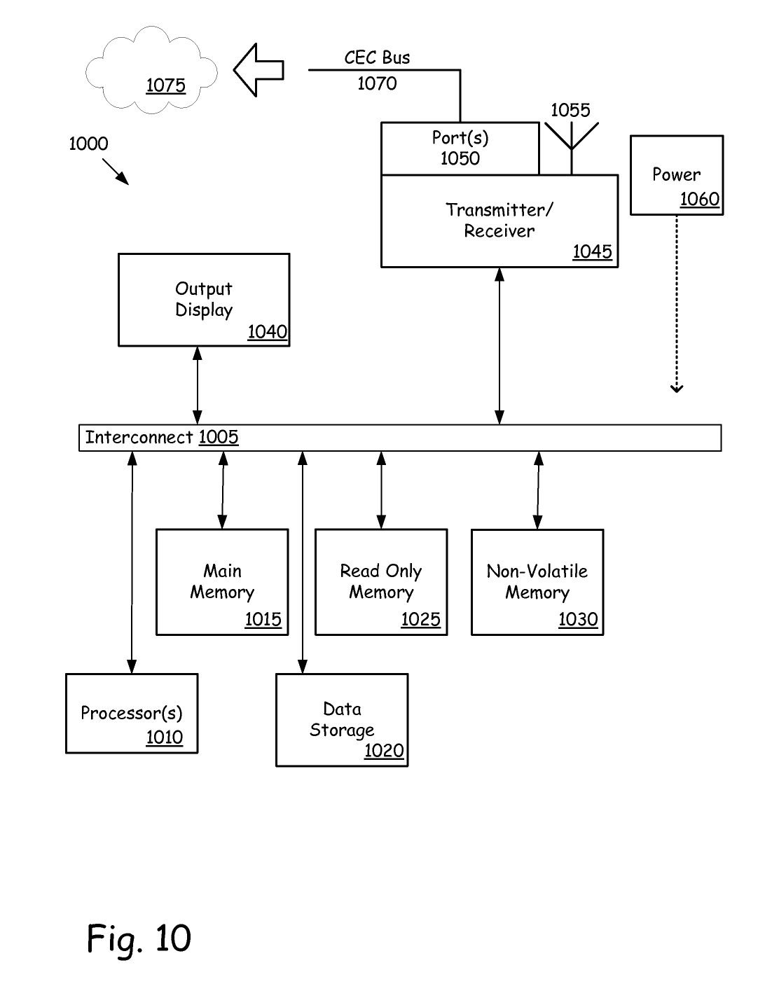

FIG. 10 illustrates an embodiment of an electronic device for transmitting or receiving signal data. In this illustration, certain standard and well-known components that are not germane to the present description are not shown. In some embodiments, the device 1000 is a device that may transmit or receive control signals on a control bus.

Under some embodiments, the device 1000 comprises an interconnect or crossbar 1005 or other communication means for transmission of data. The data may include various types of data, including, for example, audio-visual data and related control data. The device 1000 may include a processing means such as one or more processors 1010 coupled with the interconnect 1005 for processing information. The processors 1010 may comprise one or more physical processors and one or more logical processors. Further, each of the processors 1010 may include multiple processor cores. The interconnect 1005 is illustrated as a single interconnect for simplicity, but may represent multiple different interconnects or buses and the component connections to such interconnects may vary. The interconnect 1005 shown in FIG. 10 is an abstraction that represents any one or more separate physical buses, point-to-point connections, or both connected by appropriate bridges, adapters, or controllers. The interconnect 1005 may include, for example, a system bus, a PCI or PCIe bus, a HyperTransport or industry standard architecture (ISA) bus, a small computer system interface (SCSI) bus, a IIC (I2C) bus, or an Institute of Electrical and Electronics Engineers (IEEE) standard 1394 bus, sometimes referred to as “Firewire”. (“Standard for a High Performance Serial Bus” 1394-1995, IEEE, published Aug. 30, 1996, and supplements)

In some embodiments, the device 1000 further comprises a random access memory (RAM) or other dynamic storage device as a main memory 1015 for storing information and instructions to be executed by the processors 1010. Main memory 1015 also may be used for storing data for data streams or sub-streams. RAM memory includes dynamic random access memory (DRAM), which requires refreshing of memory contents, and static random access memory (SRAM), which does not require refreshing contents, but at increased cost. DRAM memory may include synchronous dynamic random access memory (SDRAM), which includes a clock signal to control signals, and extended data-out dynamic random access memory (EDO DRAM). In some embodiments, memory of the system may certain registers or other special purpose memory. The device 1000 also may comprise a read only memory (ROM) 1025 or other static storage device for storing static information and instructions for the processors 1010. The device 1000 may include one or more non-volatile memory elements 1030 for the storage of certain elements.

Data storage 1020 may also be coupled to the interconnect 1005 of the device 1000 for storing information and instructions. The data storage 1020 may include a magnetic disk or other memory device. Such elements may be combined together or may be separate components, and utilize parts of other elements of the device 1000.

The device 1000 may also be coupled via the interconnect 1005 to an output display or presentation device 1040. In some embodiments, the display 1040 may include a liquid crystal display (LCD or any other display technology, for displaying information or content to an end user. In some environments, the display 1040 may include a touch-screen that is also utilized as at least a part of an input device. In some environments, the display 1040 may be or may include an audio device, such as a speaker for providing audio information, including the audio portion of a television program.

One or more transmitters or receivers 1045 may also be coupled to the interconnect 1005. In some embodiments, the device 1000 may include one or more ports 1050 for the reception or transmission of data. The device 1000 may further include one or more antennas 1055 for the reception of data via radio signals, such as a Wi-Fi network. The transmission and reception of data may include the transfer of control data signals via a control bus such as CEC bus 1070 for transmission to another device via a packet-switched network 1075.

The device 1000 may also comprise a power device or system 1060, which may comprise a power supply, a battery, a solar cell, a fuel cell, or other system or device for providing or generating power. The power provided by the power device or system 1060 may be distributed as required to elements of the device 1000.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs that are not illustrated or described. The illustrated elements or components may also be arranged in different arrangements or orders, including the reordering of any fields or the modification of field sizes.

The present invention may include various processes. The processes of the present invention may be performed by hardware components or may be embodied in computer-readable instructions, which may be used to cause a general purpose or special purpose processor or logic circuits programmed with the instructions to perform the processes. Alternatively, the processes may be performed by a combination of hardware and software.

Portions of the present invention may be provided as a computer program product, which may include a computer-readable storage medium having stored thereon computer program instructions, which may be used to program a computer (or other electronic devices) to perform a process according to the present invention. The computer-readable storage medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/computer-readable medium suitable for storing electronic instructions. Moreover, the present invention may also be downloaded as a computer program product, wherein the program may be transferred from a remote computer to a requesting computer.

Many of the methods are described in their most basic form, but processes may be added to or deleted from any of the methods and information may be added or subtracted from any of the described messages without departing from the basic scope of the present invention. It will be apparent to those skilled in the art that many further modifications and adaptations may be made. The particular embodiments are not provided to limit the invention but to illustrate it.

If it is said that an element “A” is coupled to or with element “B,” element A may be directly coupled to element B or be indirectly coupled through, for example, element C. When the specification states that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification refers to “a” or “an” element, this does not mean there is only one of the described elements.

An embodiment is an implementation or example of the invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

What is claimed is:

1. A method comprising:
sending control signals from a first device on a first control bus, the control signals being sent according to an interface protocol, the control signals being intended for a second device;
detecting a current state of the first control bus, the current state being a control signal value driven by the first device;
inserting a control signal value representing the current state of the control bus into a first data packet; and
transmitting the first data packet to the second device via a packet-switched network.

2. The method of claim 1, wherein the protocol is HDMI™ (High-Definition Multimedia Interface) protocol and the first control bus is a CEC (Consumer Electronics Control) bus.

3. The apparatus of claim 1, further comprising determining whether one or more existing data packets are available for insertion of the value representing the current state of the control bus.

4. The method of claim 3, further comprising inserting the value presenting the current state of the control bus into a first existing data packet if the first data packet is available.

5. The method of claim 3, further comprising generating the first data packet as a new data packet and inserting the value presenting the current state of the control bus into the new existing data packet if no existing data packets are available.

6. The method of claim 1, wherein the control bus is a single-wire, bi-directional control bus.

7. The method of claim 1, wherein the operation of the transfer of data via the network is not known by the first device.

8. The method of claim 1, wherein the value representing the current state of the control bus inserted into the first data packet is a single bit.

9. The method of claim 1, further comprising receiving the transmitted first data packet and identifying the value of the current state of the first control bus.

10. The method of claim 9, further comprising driving the value of the current state of the first control bus on a second control bus for reception by the second device according to the interface protocol.

11. An apparatus comprising:
an interface with a first control bus;
an interface with a packet-switched network; and
a control circuit, where the control circuit includes:
an element to detect a current state of the first control bus, and
an element to insert a value representing the current state of the first control bus into a data packet for transmission over the packet-switched network.

12. The apparatus of claim 11, wherein the control bus is a single-wire, bi-directional control bus.

13. The apparatus of claim 12, wherein the protocol is HDMI™ (High-Definition Multimedia Interface) protocol, and wherein the first control bus is a CEC (Consumer Electronics Control) bus.

14. The apparatus of claim 11, wherein the inserted data in the data packets is a single bit.

15. The apparatus of claim 11, wherein the control circuit is to generate a data packet for transmission of the value representing the current state of the first control bus if an existing data packet is not available.

16. The apparatus of claim 11, wherein the control circuit further includes:
an element to obtain a control bus value from a data packet received on the network; and
an element to drive the control bus value on the first control bus.

17. A system comprising:
a first control bus to connect with a first electronic device;
a first control circuit coupled with the first control bus and to a packet-switched network, where the first control circuit includes:
an element to detect a current state of the first control bus, and
an element to insert a control bus value representing the current state of the first control bus into a first data packet for transmission over the packet-switched network;
a second control bus for connection with a second electronic device; and
a second control circuit coupled with the second control bus and the packet-switched network, where the second control circuit includes:
an element to obtain the control bus value from the first data packet received on the network, and
an element to drive the control bus value on the second control bus for reception by the second device.

18. The system of claim 17, wherein the first control bus and the second control bus are single-wire, bi-directional control buses.

19. The system of claim 17, wherein the protocol is HDMI™ (High-Definition Multimedia Interface) protocol, and wherein the first control bus and the second control bus are CEC (Consumer Electronics Control) buses.

20. The system of claim 17, wherein the inserted data in the first data packet is a single bit.

21. The system of claim 17, wherein the first control circuit is to generate the first data packet for transmission of the value representing the current state of the first control bus if an existing data packet is not available.

22. The system of claim 17, wherein:
the second control circuit further includes:
an element to detect a current state of the second control bus, and
an element to insert a control bus value representing the current state of the second control bus into a second data packet for transmission over the packet-switched network; and
the first control circuit further includes:
an element to obtain the control bus value from the second data packet received on the network, and
an element to drive the control bus value on the first control bus for reception by the first device.

23. A computer-readable medium having stored thereon data representing sequences of instructions that, when executed by a processor, cause the processor to perform operations comprising:
sending control signals from a first device on a first control bus, the control signals being sent according to an interface protocol, the control signals being intended for a second device;
detecting a current state of the first control bus, the current state being a control signal value driven by the first device;
inserting a control signal value representing the current state of the control bus into a first data packet; and
transmitting the first data packet to the second device via a packet-switched network.

24. The medium of claim 1, wherein the interface protocol is HDMI™ (High-Definition Multimedia Interface) protocol and the first control bus is a CEC (Consumer Electronics Control) bus.

25. The apparatus of claim 1, further comprising instructions that, when executed by the processor, cause the processor to perform operations comprising:
determining whether one or more existing data packets are available for insertion of the value representing the current state of the control bus.

26. The method of claim 25, further comprising instructions that, when executed by the processor, cause the processor to perform operations comprising
inserting the value presenting the current state of the control bus into a first existing data packet if the first data packet is available.

27. The medium of claim 25, further comprising instructions that, when executed by the processor, cause the processor to perform operations comprising:
generating the first data packet as a new data packet and inserting the value presenting the current state of the control bus into the new existing data packet if no existing data packets are available.
